(19) United States
(12) Patent Application Publication
(10) Pub. No.: US 2024/0139881 A1
(43) Pub. Date: May 2, 2024

(54) ENGRAVING MACHINE FOR ENGRAVING METALLIC AND NON-METALLIC ITEMS

(71) Applicant: THE HILLMAN GROUP, INC., Forest Park, OH (US)

(72) Inventors: David WILKINSON, Scottsdale, AZ (US); Roger PALMER, Cave Creek, AZ (US)

(73) Assignee: THE HILLMAN GROUP, INC., Forest Park, OH (US)

(21) Appl. No.: 18/468,838

(22) Filed: Sep. 18, 2023

Related U.S. Application Data
(60) Provisional application No. 63/381,322, filed on Oct. 28, 2022.

(51) Int. Cl. B23K 26/362; B23K 37/04

(52) U.S. Cl. CPC B23K 26/362; B23K 37/04

(57) ABSTRACT

An engraving machine may have a housing, a receptacle, and a laser head located within the housing. The receptacle may receive an item to be engraved. The laser head may have a laser generator. The engraving machine may have a gripper head to retrieve the item from the receptacle and to position the item relative to the laser head. The engraving machine may have a controller. The controller may receive an inscription to be engraved on the item, determine a distance of the laser head from the item, and position the laser head at the determined distance. The controller may also cause the laser generator in the laser head to emit a laser beam for engraving the item. Further, the controller may cause the gripper head to dispense the item into a dispensing bin.

### CROSS-REFERENCE TO RELATED APPLICATION

This application is based on and claims benefit of priority of U.S. Provisional Patent Application No. 63/381,322, filed Oct. 28, 2022, the entire contents of which are incorporated herein by reference.

### TECHNICAL FIELD

The present disclosure relates generally to an engraving machine and more particularly to an engraving machine capable of engraving both metallic and non-metallic items. The engraving machine of the present disclosure may have a fiber laser or a Master Laser and Optical Amplifier (MOPA) laser.

### BACKGROUND

Retail locations often have one or more engraving machines. These machines look like vending machines and allow customers to engrave one or more items (e.g. pet tags, luggage tags, etc.) with a customized inscription or message. One type of engraving machine requires a user to insert an item for engraving into the engraving machine. This type of machine also allows the user to provide information regarding a desired inscription via an input device associated with the machine. The machine then engraves the desired inscription on the item and dispenses the engraved item once the user has paid for the engraving services.

Typically, such machines may include a mechanical engraving tool or a laser. The mechanical engraving tools are limited in that they can generate limited types of engravings (sometimes known as “scratch” engravings). For example, mechanical engraving tools typically can only engrave in a handful of fonts, on a handful of materials, and cannot produce graphical inscriptions. Laser based engraving machines typically employ a carbon dioxide (CO₂) laser because it is cost effective. However, a CO₂ laser produces relatively shallow marks, which may wear easily. Moreover, such lasers typically can only etch aluminum tags. Another disadvantage of both mechanical and CO₂ laser-based engravers is that they take a long time (on the order of several minutes) to complete the engraving. Therefore, there exists a need for an engraving machine suitable for a retail environment that allows a user to engrave a variety of materials, with a variety of fonts or graphics, and at a relatively fast rate of, for example, a few seconds.

The engraving machine of the present disclosure solves one or more of the problems set forth above and/or other problems of the prior art.

### SUMMARY

In one aspect, the present disclosure is directed to an engraving machine. The engraving machine may include a housing and a receptacle in the housing. The receptacle may be configured to receive an item for engraving. The engraving machine may also include a laser head located within the housing. The laser head may include a laser generator. The engraving machine may include a gripper head configured to retrieve the item from the receptacle and to position the item relative to the laser head. The engraving machine may include a controller. The controller may be configured to receive an inscription to be engraved on the item. The controller may also be configured to determine a distance of the laser head from the item, and position the laser head at the determined distance. Further, the controller may be configured to cause the laser generator in the laser head to emit a laser beam configured to engrave the item based on the inscription. In addition, the controller may be configured to cause the gripper head to dispense the item into a dispensing bin.

In another aspect, the present disclosure is directed to a method of engraving an item. The method may include receiving an item via a receptacle in a housing of an engraving machine. The method may also include receiving an inscription to be engraved on the item. Further, the method may include positioning the item such that at least one surface of the item faces a laser generator in a laser head of the engraving machine. The method may include determining a distance of the laser head from the item, and positioning the laser head at the determined distance from the item. The method may include causing the laser generator to emit a laser beam configured to engrave the item with the inscription. In addition, the method may include dispensing the item into a dispensing bin of the engraving machine.

### BRIEF DESCRIPTION OF THE DRAWINGS

FIG. 1 is an illustration of an exemplary engraving machine;

FIG. 2 is a partial cut-away illustration of the engraving machine of FIG. 1;

FIG. 3 is another partial cut-away illustration of the engraving machine of FIG. 1;

FIGS. 4A-4C are illustrations of varying focal planes of a laser beam of the engraving machine of FIG. 1;

FIG. 5 is a partial cut-away illustration showing a rear view of a laser head in the engraving machine of FIG. 1;

FIG. 6 is an illustration of an exemplary laser beam control assembly of the engraving machine of FIG. 1; and

FIG. 7 is a flow chart of an exemplary method performed by the engraving machine of FIG. 1.

### DETAILED DESCRIPTION

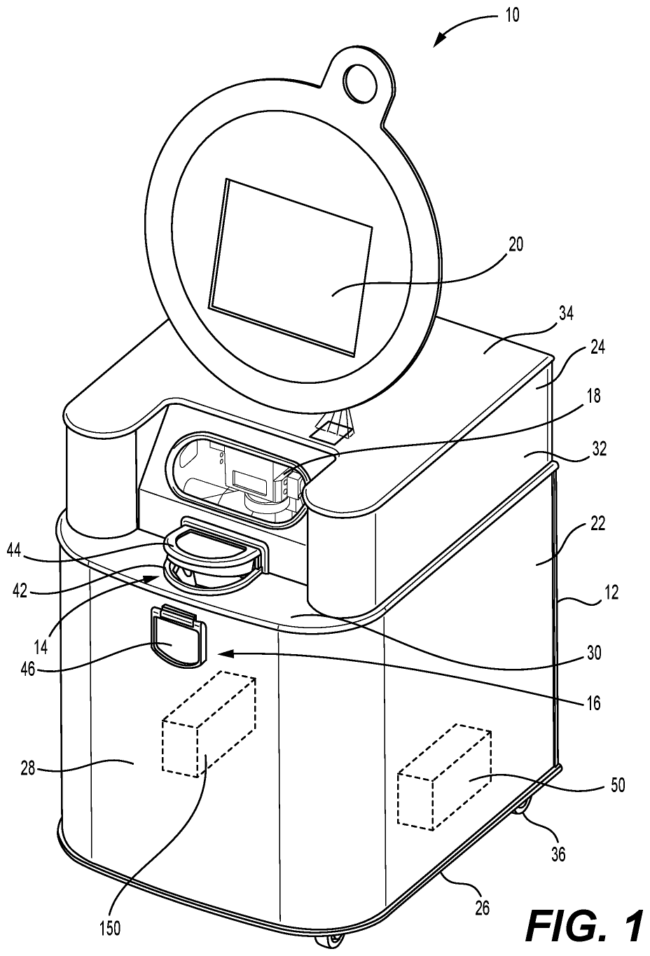

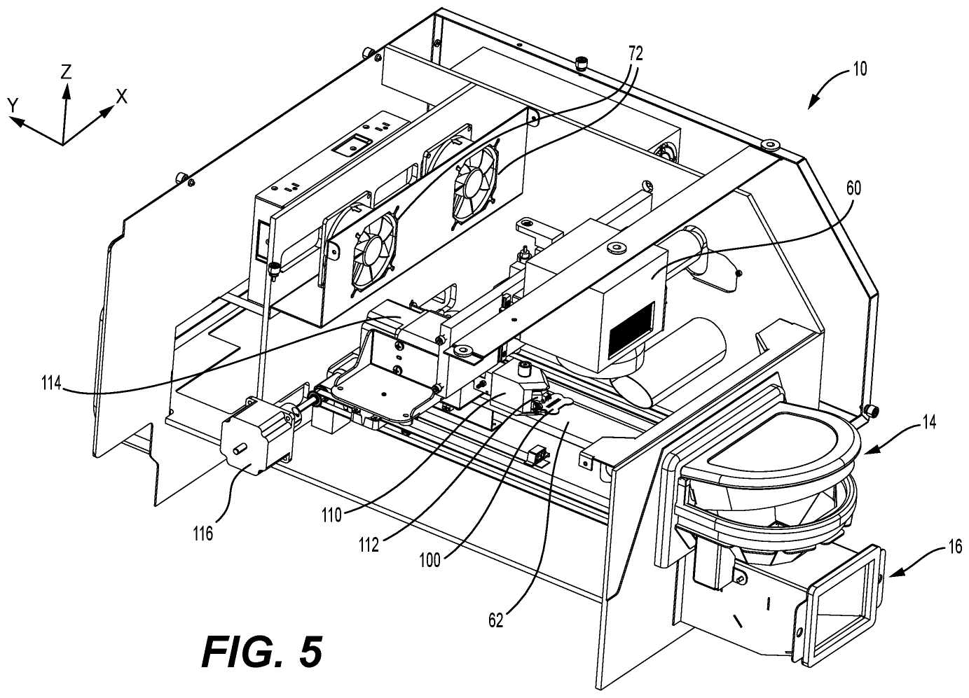

FIG. 1 illustrates an exemplary engraving machine 10. In one exemplary embodiment as illustrated in FIG. 1, engraving machine 10 may be a kiosk, having a size and shape similar to, for example, a telephone booth, an ATM machine, or a vending machine usually available at commercial or retail locations such as at grocery or hardware stores, shopping malls, or airports. Engraving machine 10 may be configured to engrave an item 100 (see FIG. 5) that a user provides to engraving machine 10 for engraving item 100 with an inscription. For purposes of this disclosure, the term “item” is intended to include any product or good that is or may be sold with a personalized inscription. Examples of such items 100 may include, but are not limited to, identification (“ID”) tags (e.g. pet ID tags, luggage ID tags, name plates, etc.), key chains, tourism mementos, holiday gifts, tournament plaques, etc. An inscription may include textual matter, graphical matter, bar codes or QR codes, images, or any other type of written or graphical material.

Engraving machine 10 may include housing 12, receptacle 14, dispensing bin 16, viewing window 18, and display 20. Housing 12 may be in the form of an enclosure, and may include lower portion 22 and upper portion 24. Lower portion 22 may be an enclosure defined by base 26, side panels 28, and top panel 30. Upper portion 24 may be an enclosure disposed on or extending from lower portion 22. Upper portion 24 may include side panels 32 and top panel 34. It is contemplated that top panel 30 may include an opening extending between the enclosures of lower portion 22 and upper portion 24 so that lower portion 22 and upper portion 24 may define a single contiguous enclosure. Housing 12 may be equipped with one or more wheels 36 to allow engraving machine 10 to be easily moved on a floor of a retail establishment.

In one exemplary embodiment as illustrated in FIG. 1, receptacle 14 may extend from upper portion 24 and may include tray 42 resting on top panel 30. Receptacle 14 may also include cover 44 that may be movable relative to tray 42. In one exemplary embodiment, cover 44 may be pivotably movable relative to tray 42. A user may be able to lift cover 44 and place an item (not shown) for engraving in tray 42. In some exemplary embodiments, receptacle 14 may be equipped with a post or a hook (not shown) configured to pass through an opening in item 100 (see FIG. 5) to help locate item 100 within receptacle 14. It is contemplated that receptacle 14 may alternatively extend from lower portion 22 or may be positioned on any other surface of housing 12. After the engraving is complete, the engraved item 100 may be dispensed to the user via dispensing bin 16. In one exemplary embodiment, dispensing bin 16 may include a door 46 that may prevent access to dispensing bin 16 during the engraving process and that may retract or be movable only after the engraved item 100 has been dispensed to dispensing bin 16. For example, door 46 may be configured to be opened by the user, after the engraving process is complete, for retrieving the engraved item 100 from dispensing bin 16.

Although not illustrated in FIG. 1, engraving machine 10 may include a cash acceptor, a payment capture device, and or one or more input devices. The cash acceptor may be configured to receive currency in the form of bills or coins as payment from a customer. The payment capture device may be a credit card or debit card reader. In some exemplary embodiments, the payment capture device may be configured to accept other types of payment such as checks or other forms of electronic payment. In some exemplary embodiments, the payment capture device may be configured to receive payment via wireless communication with another electronic device, for example, a mobile phone, a tablet computer, a laptop computer, a remote server, etc. It is also contemplated that in some exemplary embodiments, the payment capture device may be configured to receive and/or dispense currency in the form of bills and/or coins obviating the need for a separate cash acceptor. It is contemplated that housing 12 may include any number of cash acceptors and/or payment capture devices.

It is also contemplated that in some exemplary embodiments, engraving machine 10 may not include any type of payment device. Instead, the user may be required to make payment for the engraving services elsewhere. The user may be provided with a bar code or QR code and engraving machine 10 may be equipped with a suitable scanner (not shown). The scanner may be configured to scan the bar code or QR code to verify that the user has paid for the engraving services. In some exemplary embodiments, the bar code or QR code may be positioned on item 100 and a user may be required to present the bar code or QR code on item 100 to the scanner on engraving machine 10 before item 100 may be engraved. It is further contemplated that item 100 may include a tag or marking including a bar code or a QR code associated with a SKU of item 100. The scanner in engraving machine 10 may read the bar code or QR code on item 100 to verify that the correct item 100 is being presented for engraving.

Engraving machine 10 may additionally or alternatively include one or more input devices located on housing 12. The one or more input devices may include one or more physical keyboards, mice, joysticks, buttons, touchscreens, touch pads, etc. In some exemplary embodiments, the one or more input devices may be ADA (Americans With Disabilities Act) compliant devices. It is also contemplated that in some exemplary embodiments, the input devices may be configured to receive a speech input or braille input from a user.

Display 20 may be disposed on or extend from upper portion 24. It is contemplated, however, that display 20 may be located anywhere on housing 12 (e.g. on side panels 28 or 32) of engraving machine 10. Display 20 may include a conventional display device, for example, an LCD screen, an LED screen, a cathode ray tube screen, etc. In some exemplary embodiments, display 20 may be configured to display a graphical user interface, including instructions, advertising, and/or other information. In some exemplary embodiments, display 20 may additionally or alternatively include a touch screen device configured to receive one or more inputs from a user. Thus, for example, a graphical user interface displayed on display 20 may allow a user to specify text for a desired inscription, accept or reject a displayed price, and/or request help on using engraving machine 10. In some exemplary embodiments, the graphical user interface may also allow the user to specify one or more fonts and/or colors for the desired inscription. Display 20 may be configured to display a virtual keyboard or numeric keypad, which may allow a user to enter payment information, address information, inscription information, and/or other information associated with engraving an item using engraving machine 10.

In some exemplary embodiments, engraving machine 10 may include communications device 50. Communications device 50 may be configured to send data or instructions to a remote server (not shown), database (not shown) and/or user device (not shown) wirelessly or through a wired connection via a network. Communications device 50 may include a modem, a wired or wireless transceiver, or other device capable of transmitting and/or receiving data and/or instructions. For example, a user may be able to upload a graphical image, photograph, icon, inscription, or other graphical media via communications device 50 to engraving machine 10. In some exemplary embodiments, the user may be able to upload the graphical image, photograph, icon, inscription, or other graphical media from a user device to engraving machine 10 via communication device 50. A user device may include, for example, a smartphone, a laptop or desktop computer, a tablet computer, a smartwatch, smartglasses, and/or photographic or video equipment. In some embodiments, the user may also be able to use the one or more input devices and/or the graphical user interface on the display to input the graphical image, photograph, icon, inscription, or other graphical media into engraving machine 10 and/or to customize the uploaded or inputted graphical item or inscription and/or arrange and/or resize the graphical information or inscription to fit on item 100 to be engraved. Communications device 50 may also be configured to transmit diagnostic information regarding engraving machine 10 to the remote server. For example, such diagnostic information may include alerts regarding maintenance or repair that may be determined based on monitoring of one or more sensors associated with engraving machine 10. Additionally or alternatively, communications device 50 may be configured to receive updates to the software or instructions used for operation and or diagnostics associated with engraving machine 10. Further still, communications device 50 may be configured to receive updated instructions regarding pricing and/or display of one or more graphical user interfaces or instructions on display 20. In some embodiments, communications device 50 may also transmit information regarding usage of engraving machine 10 (e.g., number of hours of operation, number of items engraved, types of items engraved, types of inscriptions engraved by users) and/or any other type of usage, diagnostic, repair, or operational information associated with engraving machine 10.

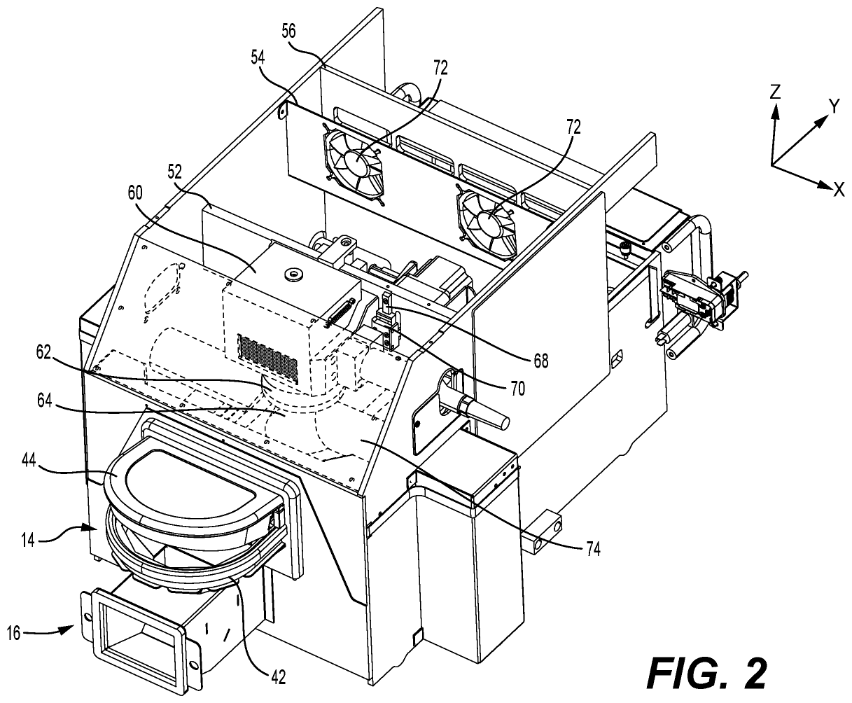

FIG. 2 illustrates a partial cut-away view of an exemplary engraving machine 10. As illustrated in FIG. 2, engraving machine 10 may include one or more internal partitions 52, 54, 56 configured to support one or more components of engraving machine 10. In one exemplary embodiment as illustrated in FIG. 2, partition 52 may be configured to support laser head 60 that may be movable relative to partition 52. Laser head 60 may include one or more laser generators 62 configured to emit pulses of laser radiation towards engraving portion 64. In some exemplary embodiments, laser generator 62 may include a carbon dioxide (CO₂) laser that may have a wavelength of about 10,200 nano meters (nm) and a laser spot size ten times the diameter of the laser beam. It is contemplated that laser generator 62 with a CO₂ laser of the present disclosure may be configured to engrave items made of, for example, plastic material or aluminum. In some exemplary embodiments, laser generator 62 may additionally or alternatively include a fiber laser. In some exemplary embodiments, the fiber laser may include a solid state diode fiber laser. In other exemplary embodiments, the fiber laser may be a 20 Watt (W) laser with a wavelength of 1064 nm and a spot size that may be 10 times smaller than a spot size achievable by the CO₂ laser. It is contemplated that laser generator 62 with a fiber laser may be configured to engrave items made of, for example, brass, chrome plated metals, stainless steel, titanium, PVD coated materials, other metallic and non-metallic materials, Polyethylene Terephthalate (PET) material, Thermoplastic Polyurethane (TPU) material, and/or plastic material with laser modifiers (e.g., titanium dioxide or carbon black). It is further contemplated that in some exemplary embodiments, laser generator 62 may additionally or alternatively include a Master Laser and Optical Amplifier (MOPA) laser. Laser generator 62 with a MOPA laser may also be configured to engrave items made of, for example, brass, chrome plated metals, stainless steel, titanium, PVD coated materials, other metallic and non-metallic materials, Polyethylene Terephthalate (PET) material, Thermoplastic Polyurethane (TPU) material, and/or plastic material with laser modifiers (e.g., titanium dioxide or carbon black).

Laser head 60 may be movable in a vertical direction (in the direction Z) towards or away from engraving portion 64 of engraving machine 10. Thus, for example, laser head 60 may be movable in a direction generally perpendicular to item 100. In one exemplary embodiment as illustrated in FIG. 2, partition 52 of engraving machine 10 may be equipped with rails or linear motion guides 68 (right side rail 68 visible in FIG. 2, left side rail 68 is hidden). Laser head 60 may be equipped with sliders 70 (right side slider 70 visible in FIG. 2, left side slider 70 is hidden) configured to slide along rails 68. In some embodiments, sliders 70 may be removably or fixedly attached to laser head 60. Sliders 70 may be configured to support laser head 60. Sliders 70 may also be configured to slidably move along rails 68 so that laser head 60 is configured to move along the vertical Z direction (e.g., generally perpendicular to engraving portion 64 and item 100) without any appreciable movement in the transverse X or Y directions illustrated in FIG. 2. Movement of laser head 60 in the Z direction may help to change the focal plane of a laser beam emitted by laser generator 62. That is, movement of laser head 60 in the Z direction may help to change a size of the laser beam spot impinging on item 100 (see FIG. 5) to be engraved allowing for markings of varying width and or depth to be generated on the item. Laser head 60 may include one or more collimators, mirrors, lenses, prisms, or other optical elements configured to direct a laser beam from laser generator 62 onto item 100 during the engraving process.

As also illustrated in FIG. 2, engraving machine 10 may include one or more fans 72 configured to cool laser head 60 and/or other components within engraving machine 10. Similarly, engraving machine 10 may include one or more debris collection tubes 74 that may cooperate with one or more vacuum generators to remove any smoke, dirt, or debris generated during operation of engraving machine 10.

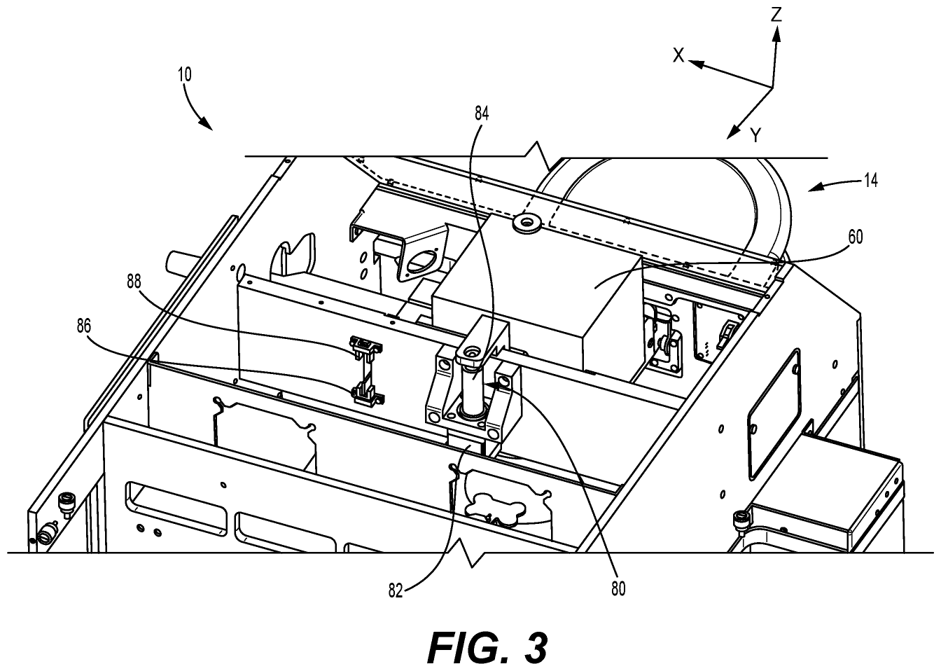

FIG. 3 illustrates another partial cut-away view of exemplary engraving machine 10, showing a rear view of laser head 60. As illustrated in FIG. 3, laser head 60 may be equipped with actuator 80 that may be configured to move laser head 60 vertically upwards or downwards along direction Z. In one exemplary embodiment, actuator 80 may include stepper motor 82 and drive shaft 84. Rotation of stepper motor 82 in a clockwise or counterclockwise direction with corresponding rotation of drive shaft 84 may cause laser head 60 to be moved vertically upwards or downwards along direction Z. It is contemplated, however, that actuator 80 may take other forms, for example, a rack and pinion arrangement, a hydraulic or pneumatic actuator, a chain drive, a belt drive, or any other mechanical structure capable of moving laser head 60 vertically upwards or downwards along direction Z.

Engraving machine 10 may also include switches 86 and 88. In one exemplary embodiment, switches 86 and 88 may be optical limit switches that may help limit movement of laser head 60. For example, switch 86 may be a home switch that may define the lowest possible position (e.g., second position) of laser head 60 relative to engraving portion 64 or item 100 when positioned below laser head 60. Switch 86 may be configured to generate a signal when laser head 60 reaches the lowest possible position when being moved by actuator 80. Similarly, switch 88 may be an over travel switch that may define the highest allowable position (e.g., first position) of laser head 60 relative to engraving portion 64 or item 100 when positioned below laser head 60. Switch 88 may be configured to generate a signal when laser head 60 reaches the highest allowable position when being moved by actuator 80. At its lowest position (or second position), laser head 60 may be located nearer to item 100 than when laser head 60 is located at its highest allowable position (or first position). Although switches 86 and 88 have been described as optical limit switches, it is contemplated that switches 86, 88 may include electrically triggered, mechanically triggered, acoustically triggered, or any other type of switches or sensors capable of generating a signal when laser head 60 reaches the home or over travel position. The signal generated by switch 86 or 88 may be used to stop movement of actuator 80 and therefore a movement of laser head 60 so as to maintain the position of laser head 60 at the home or over travel position. For example, controller 150 (see FIG. 1) may receive signals generated by switch 86 or 88. When controller 150 receives the signal generated by switch 86, controller 150 may control actuator 80 to stop movement of laser head 60 so that the position of laser head 60 is maintained at the lowest possible position (or home position). Likewise, when controller 150 receives the signal generated by switch 88, controller 150 may control actuator 80 to stop movement of laser head 60 so that the position of laser head 60 is maintained at the highest allowable position (or overtravel position).

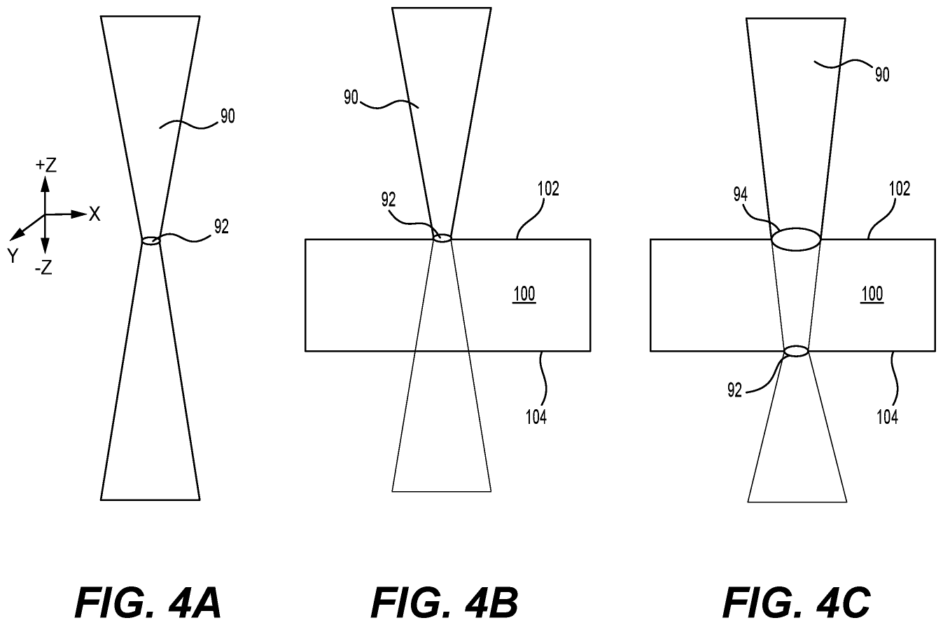

FIG. 4A illustrates an exemplary laser beam 90 emitted by laser generator 62. As illustrated in FIG. 4A, engraving machine 10 may include one or more optical elements (e.g., lenses, mirrors, prisms) that may be configured to focus laser beam 90 to converge towards a laser spot 92 having a predetermined diameter. As also illustrated in FIG. 4A, laser beam 90 may diverge (e.g., increase in diameter) in the negative Z direction away from laser spot 92. FIGS. 4B and 4C illustrates exemplary configurations for focusing laser beam 90 on item 100 to be engraved. As illustrated in FIG. 4B, laser head 60 may be vertically positioned to focus laser beam 90 so that laser spot 92 having its smallest diameter may be formed on an upper surface 102 of item 100 (e.g., when upper surface 102 lies on a focal plane of laser beam 90). In contrast, as illustrated in FIG. 4C, laser head 60 may be vertically positioned to focus laser beam 90 so that laser spot 92 having its smallest diameter may be formed on a lower surface 104 of item 100 (e.g., when lower surface 104 lies on a focal plane of laser beam 90). In this condition, laser beam 90 may not be in focus on upper surface 102 of item 100. When laser beam 90 is not in focus on upper surface 102, the energy of the laser beam is dispersed. The amount of dispersion of the energy (or an amount by which laser beam 90 is out of focus relative to upper surface 102) may be determined based on absorption properties of the material of item 100. Thus, a larger laser spot 94 may be formed on upper surface 102 of item 100. It is contemplated that laser head 60 may be variably positioned to generate laser spots of different diameters (e.g., 92, 94) on upper surface 102 of item 100. Because the amount of dispersion of the energy depends on the position of laser head 60 relative to item 100, the position of laser head 60 may be adjusted relative to item 100 to generate one or more colors on item 100 during the engraving process. It is contemplated that the vertical position of laser head 60 (or a distance of laser head 60 relative to item 100), and therefore, a size of laser spot 94 may additionally or alternatively be determined based on a material of item 100 or thickness of item 100. It is further contemplated that the vertical position of laser head 60 and, therefore, a size of laser spot 94 may additionally or alternatively be determined based on the inscription that is to be engraved on item 100. For example, a relatively larger size of laser spot 94 (e.g., a spot that is more out of focus) may be desirable when engraving certain graphical features (e.g., images, icons, QR codes etc.) on item 100 as opposed to when engraving textual matter on item 100. It is further contemplated that if item 100 is curved (e.g., ring, bracelet, curved tag), a vertical position of laser head 60 relative to item 100 may be continuously or periodically adjusted during the engraving process to ensure a same size of laser spot 92 or 94 is used over some or all portions of item 100. In some embodiments, when the radius of curvature of item 100 is greater than or equal to a predetermined threshold (e.g., ±2 mm), a vertical position of laser head 60 may not be changed, whereas when the radius of curvature of item 100 is less than the predetermined threshold, the vertical position of laser head 60 may be continuously or periodically adjusted to account for the curvature of item 100.

FIG. 5 illustrates another partial cut-away view of exemplary engraving machine 10. As illustrated in FIG. 5, engraving machine 10 may include gripper head 110 that may be configured to grasp or hold item 100 to be engraved. Gripper head 110 may include one or more jaws 112 that may be movable relative to each other. Jaws 112 may be configured to grip or hold item 100 during the engraving process. Gripper head 110 may be connected to actuators 114 and 116. Actuator 114 may be configured to allow gripper head 110 to move in a transverse or Y direction towards or away from receptacle 14. For example, when a user places item 100 into receptacle 14, jaws 112 may hold item 100 and actuator 114 may be configured to retract gripper head 110 into engraving machine in a +Y direction away from receptacle 14 and towards engraving portion 64 such that item 100 is positioned below laser head 60 or below laser generator 62. It is also contemplated that gripper head 110 may include one or more sensors configured to determine a thickness of item 100. For example, jaws 112 may be equipped with one or more sensors configured to determine a distance between jaws 112, which may be indicative of a thickness of item 100 when jaws 112 grip item 100. Actuator 114 may also be configured to allow gripper head 110 to rotate clockwise or counterclockwise about its longitudinal axis (e.g., along axis Y). Thus, actuator 114 may allow one or both sides of item 100 to be positioned to face laser head 60 to allow for engraving one or both sides of item 100. Actuator 116 may be configured to allow gripper head 110 and, therefore, item 100 to be moved sideways along the X direction (e.g., transverse to the laser beam or to the Z direction). Thus, during engraving, actuators 114 and/or 116 may be configured to move item 100 in the +X, −X, +Y, and/or −Y directions to allow laser beam 90 emitted by laser generator 62 to impinge on different portions of item 100 to perform the engraving. Like actuator 80, actuators 114, 116 may include one or more of stepper motors, rack and pinion arrangements, belt drives, chain drives, pneumatic or hydraulic actuators, and/or any other mechanical structure capable of moving gripper head 110 as described above.

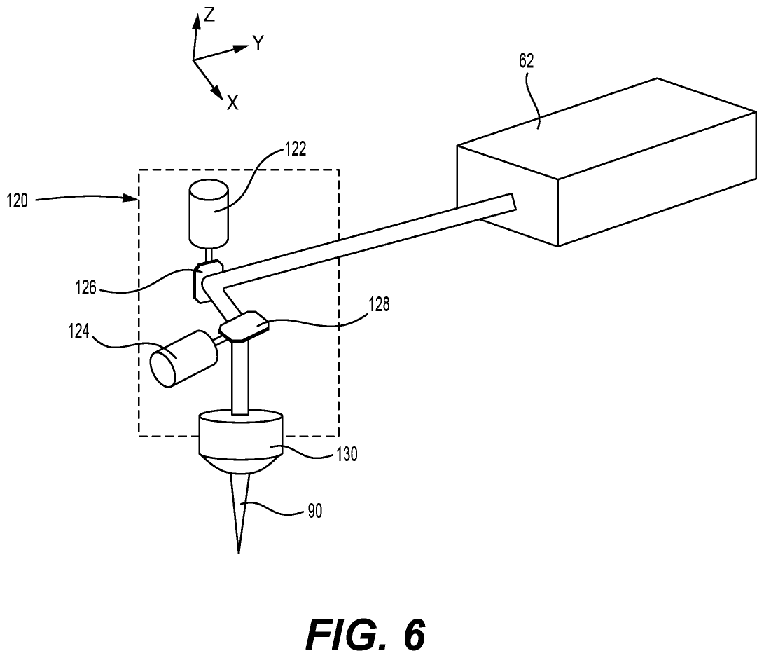

FIG. 6 illustrates an exemplary laser beam control assembly 120 within laser head 60. For example, as illustrated in FIG. 6, laser generator 62 may emit laser beam 90 that may be directed towards laser beam control assembly 120. Laser beam control assembly 120 may include galvanometer heads 122 and 124 and optical elements 126, 128, and 130. Galvanometer heads 122 and 124 may be configured to rotate optical elements 126 and 128 about axes Z and Y, respectively. Optical elements 126, 128, and 130 may include one or more of mirrors, lenses, prisms, or any other type of optical device capable of directing a laser beam 90. Optical element 126 may be configured to direct laser beam 90 emitted by laser generator 62 towards optical element 128, which in turn may be configured to direct laser beam 90 towards optical element 130. Optical element 130 may be configured to focus laser beam 90 and generate a laser spot 92 or 94 having a size or diameter based on a vertical position of laser head 60 relative to item 100 and/or engraving portion 64.

In some exemplary embodiments, in addition to or instead of moving item 100 in the transverse +X, −X, +Y, and/or −Y directions during engraving, galvanometer heads 122 and 124 may allow laser beam 90 to move continuously along one or more curved surface or edge (e.g., vector type marking scheme) instead of moving in raster fashion (e.g., along rows and columns, or raster type marking scheme) to engrave the inscription on item 100. This may allow engraving machine 10 to generate inscriptions on item 100 using a vector marking scheme, thereby providing smoother and sharper edges as opposed to the pixelated edges generated using a raster marking scheme. Additionally, such vector marking may allow inscriptions to be generated on item 100 at a significantly faster rate. This in turn may allow the laser beam to be impinged on item 100 multiple times to generate a deeper inscription and/or to generate different types of geometrical shapes and/or colors of the grooves generated on item 100. It is contemplated that galvanometer heads 122 and 124 and actuators 114, 116 may be controlled (e.g., by controller 150) to move the laser head based on either or both of a raster type marking scheme or a vector type marking scheme for generating the inscriptions on item 100. Selection of raster or vector marking scheme may be based on the content of the inscription that is to be engraved on item 100. For example, an inscription in cursive font may require the use of the vector marking scheme to generate smoother edges of the cursive font. In contrast, for example, an inscription including a polygonal or other geometric figure may be generated using a raster marking scheme in which the laser beam is moved in raster fashion (e.g., along rows and columns).

In some exemplary embodiments, engraving machine 10 may include controller 150 (see FIG. 1) that may be configured to control operations of various components (e.g. cash acceptor, payment capture device, input devices, display 20, actuators 80, 114, 116, galvanometer heads 122, 124) of engraving machine 10. Controller 150 may include one or more processors and/or one or more memory devices. Controller 150 may also be configured to receive and/or send signals to one or more of cash acceptor, payment capture device, input devices, display 20, actuators 80, 114, 116, galvanometer heads 122, 124, communications device 50, and/or one or more sensors, other actuators, and/or locks associated with engraving machine 10. Controller 150 may also be configured to send or receive signals to an offboard processor and/or server or to one or more other engraving machines 10 via communications device 50. Controller 150 may be configured to receive and/or send signals through one or more wired connections or wirelessly via communications device 50.

The processor of controller 150 may embody a single microprocessor or multiple microprocessors, digital signal processors (DSPs), etc. Numerous commercially available microprocessors may be configured to perform the processor functions. Various other known circuits may be associated with the processor, including power supply circuitry, signal-conditioning circuitry, and communication circuitry. The one or more memory devices associated with controller 150 may store, for example, data and/or one or more control routines or instructions for processing the one or more signals, and/or to control operations of one or more components of engraving machine 10. The one or more memory devices may embody non-transitory computer-readable media, for example, Random Access Memory (RAM) devices, NOR or NAND flash memory devices, and Read Only Memory (ROM) devices, CD-ROMs, hard disks, floppy drives, optical media, solid state storage media, etc. Controller 150 may receive one or more input signals from one or more of display 20 or other input devices associated with engraving machine 10 and may execute the routines or instructions stored in the one or more memory devices to generate and deliver one or more command signals to one or more components of engraving machine 10.

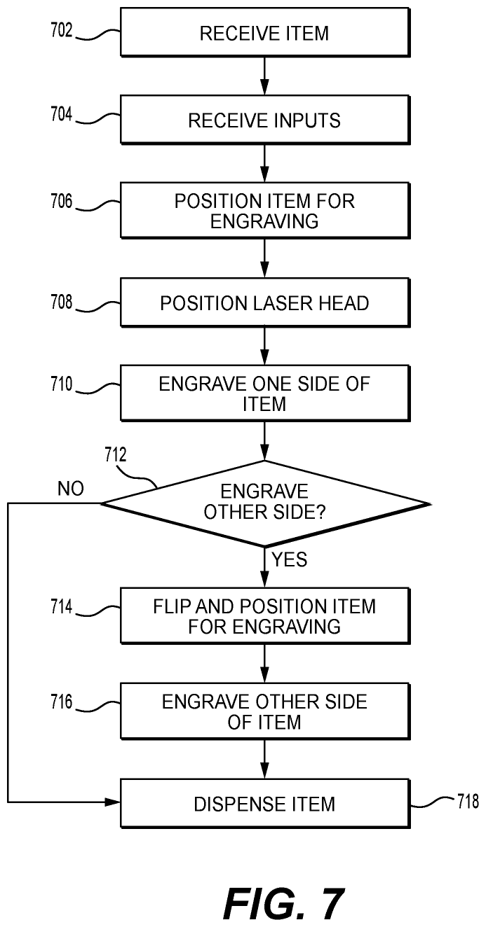

FIG. 7 illustrates an exemplary method 700 of an engraving operation that may be performed by engraving machine 10. The order and arrangement of steps of method 700 is provided for purposes of illustration. As will be appreciated from this disclosure, modifications may be made to method 700 by, for example, adding, combining, removing, and/or rearranging the steps of method 700. Method 700 may be executed by controller 150 together with various other components of engraving machine 10.

Method 700 may include a step of receiving an item from a user (Step 702). In operation, a user (e.g. customer) may initiate an interaction with engraving machine 10 by, for example, pressing a “start” button displayed on, for example, a touch-screen display 20, or by touching the touch-screen display 20. Display 20 may send a signal to controller 150 indicating pressing of the “start button” or detection of a touch on display 20. In response, controller 150 may provide additional instructions to the user via display 20. For example, controller 150 may instruct the user to place an item 100 for engraving into receptacle 14. Controller 150 may determine whether item 100 has been placed into receptacle 14 by monitoring one or more sensors (e.g., cameras, weight sensors, optical switches, or other sensors) of engraving machine 10.

In step 704, controller 150 may receive additional inputs from the user. For example, controller 150 may display instructions on display 20, requesting the user to indicate whether the user wants to engrave one side or both sides of item 100. Controller 150 may also display instructions on display 20, requesting the user to enter a desired inscription for one or both sides of item 100 based on the user selection. Controller 150 may receive the one or more user inputs and/or selections (including, for example, an inscription) via the one or more input devices and/or via touch-screen display 20. After receiving the user selections and inputs, controller 150 may display a price on display 20, and request the user to make payment using either cash acceptor and/or payment capture device. Controller 150 may monitor signals from cash acceptor and/or payment capture device to determine whether the required amount of money has been paid. When controller 150 determines that adequate amount of payment has been made, controller 150 may proceed to step 706.

In step 706, controller 150 may control jaws 112 of gripper head 110 to hold item 100 placed in receptacle 14. It is contemplated that gripper head 110 may include one or more sensors configured to determine a distance between jaws 112 to determine a thickness of item 100. In some exemplary embodiments, controller 150 may receive signals from the one or more sensors in gripper head 110 indicative of the thickness of item 100. In some exemplary embodiments, the user may input the thickness of item 100 using one or more I/O devices associated with engraving machine 10 and controller 150 may receive user input of the thickness of item 100. Controller 150 may also control actuator 114 to retract gripper head 110 with item 100 from receptacle 14 and position item 100 in engraving portion 64 below laser head 60 and/or below laser generator 62. Controller 150 may also control gripper head 110 to rotate item 100 and so that the surface or side of item 100 that is to be engraved is facing laser head 60.

In step 708, controller 150 may control actuator 80 to move laser head 60 vertically upwards or downwards to adjust the focal plane of laser beam 90 relative to item 100. Controller 150 may determine a position of laser head 60 (and thus a distance of laser head 60 from item 100) based on a material composition of item 100. For example, controller 150 may move laser head 60 towards item 100 to ensure laser beam 90 is focused on lower surface 104 or at a position below lower surface 104 when item 100 is made of a plastic material. Doing so may generate a larger laser spot 94 on upper surface 104 of item 100. In contrast, controller 150 may move laser head 60 away from item 100 to ensure laser beam 90 is focused on upper surface 102 when item 100 is made of a metallic material. Controller 150 may determine the material of item 100 based on information associated with item 100 from a database or data structure stored in one or more associated memory devices or based on an input provided by the user. In some exemplary embodiments, controller 150 may determine a position of laser head 60 based on the contents of the inscription. For example, when the inscription includes graphical items or a QR code, controller 150 may position laser head 60 such that laser beam 90 is not focused on upper surface 102 of item 100 but may be focused at a location between upper surface 102 and lower surface 104 or at any other vertical position such that a predetermined diameter of a laser spot 94 is obtained on upper surface 102 of item 100. In some exemplary embodiments, controller 150 may determine and adjust a vertical position of laser head 60 based on a shape (e.g., curvature) of item 100. It is also contemplated that in some exemplary embodiments, controller 150 may determine and adjust the vertical position of laser head 60 based on a thickness of item 100. Controller 150 may use look-up tables, mathematical expressions, database records, one or more algorithms, and/or machine learning models to determine the vertical position (or distance) of laser head 60 relative to item 100. For example, a machine learning model may be trained using training data that may include one or more of a thickness, geometrical properties of an inscription, curvature of an inscription, one or more colors of the inscription together with a distance of laser head 60 relative to item 100. An inscription (e.g., in the form of an image or other data) when provided as an input to the machine learning model may output the distance of laser head 60 relative to item 100 required to form that inscription on item 100.

Method 700 may include a step of engraving item 100 (Step 710). Controller 150 may control actuators 114, 116, and/or galvanometer heads 122, 124 to move laser beam 90 and/or item 100 to allow laser beam 90 to engrave the desired inscription on a surface of item 100 facing laser head 60. In some embodiments, controller 150 may cause laser beam 90 to be impinged more than once on some or all portions of item 100 to generate deeper grooves or to generate desired colors on some or all portions of the inscription on item 100. Controller 150 may monitor laser generator 62 and/or one or more other sensors associated with engraving machine 10 to determine whether engraving is complete on the surface of item 100 facing laser generator 62.

Method 700 may include a step of determining whether it is required to engrave the other side or surface of item 100 (Step 712). Controller 150 may make this determination based on inputs received from the user, for example, in step 704. When controller 150 determines that the user desires to engrave the other side of item 100 (Step 712: Yes), controller 150 may proceed to step 714. When controller 150 determines, however, that the user does not desire to engrave the other side of item 100 (Step 712: No), controller 150 may proceed to step 718.

In step 714, controller 150 may control actuator 80 to rotate gripper head 110 so that item 100 is flipped over, allowing the other, unengraved surface of item 100 to face laser head 60. In step 716, Controller 150 may execute processes similar to those discussed above, for example, in step 710 to engrave the other surface of item 100.

Method 700 may include a step of dispensing item 100 (Step 718). In step 718, controller 150 may control actuator 80 to move gripper head 110 towards dispensing bin 16. Controller 150 may also control one or more ejector mechanisms associated with gripper head 110 to eject item 100 and allow it to drop into dispensing bin 16. Controller 150 may also send signals to one or more controllers associated with door 46 of dispensing bin 16 to unlock door 46 and allow door 46 to be movable by a user.

It will be apparent to those skilled in the art that various modifications and variations can be made to the disclosed engraving machine. Other embodiments will be apparent to those skilled in the art from consideration of the specification and practice of the disclosed engraving machine. It is intended that the specification and examples be considered as exemplary only, with a true scope being indicated by the following claims and their equivalents.

What is claimed is:

1. An engraving machine, comprising:
a housing;
a receptacle in the housing, the receptacle being configured to receive an item for engraving;
a laser head located within the housing, the laser head including a laser generator;
a gripper head configured to retrieve the item from the receptacle and to position the item relative to the laser head; and
a controller configured to:
receive an inscription to be engraved on the item;
determine a distance of the laser head from the item;
position the laser head at the determined distance;
cause the laser generator in the laser head to emit a laser beam configured to engrave the item based on the inscription; and
cause the gripper head to dispense the item into a dispensing bin.

2. The engraving machine of claim 1, wherein the laser generator includes a fiber laser.

3. The engraving machine of claim 1, wherein the laser generator includes a Master Laser and Optical Amplifier (MOPA) laser.

4. The engraving machine of claim 1, wherein the controller is configured to determine the distance of the laser head based on at least one of a material of the item, a thickness of the item, the inscription to be engraved on the item, or a curvature of the item.

5. The engraving machine of claim 1, wherein the controller is configured to move the gripper head transverse to the laser beam to cause the item to be engraved with the inscription.

6. The engraving machine of claim 1, wherein the controller is configured to continuously adjust the position of the laser head relative to the item as the laser beam engraves the item based on a curvature of the item.

7. The engraving machine of claim 1, further including a communication device configured to send or receive data or instructions.

8. The engraving machine of claim 7, wherein
the communication device is configured to receive the inscription from a user device.

9. The engraving machine of claim 1, further including an actuator configured to move the laser head relative to the item.

10. The engraving machine of claim 9, further including at least one sensor configured to generate a signal based on a position of the laser head relative to the item.

11. The engraving machine of claim 10, wherein the at least one sensor includes:
a first switch configured to generate a first signal when the laser head is located at a first position relative to the item; and
a second switch configured to generate a second signal when the laser head is located at a second position relative to the item, the laser head being located nearer to the item in the second position as compared with the first position.

12. The engraving machine of claim 11, wherein the controller is further configured to:
stop movement of the actuator upon receiving the first signal to maintain the laser head at the first position; and
stop the movement of the actuator upon receiving the second signal to maintain the laser head at the first position.

13. The engraving machine of claim 1, wherein the gripper head includes a pair of jaws configured to grip the item and position a first side of the item to face the laser head.

14. The engraving machine of claim 13, wherein the gripper head is configured to:
rotate about a longitudinal axis of the gripper head; and
position a second side of the item to face the laser head, the second side of the item being opposite the first side of the item.

15. The engraving machine of claim 1, further including:
at least one guide rail; and
a slider attached to the laser head and configured to slidably move along the guide rail such that the laser head is moved in a direction generally perpendicular to the item.

16. A method of engraving an item, comprising:
receiving the item via a receptacle in a housing of an engraving machine;
receiving an inscription to be engraved on the item;
positioning the item such that at least one surface of the item faces a laser generator in a laser head of the engraving machine;
determining a distance of the laser head from the item;
positioning the laser head at the determined distance from the item;
causing the laser generator to emit a laser beam configured to engrave the item with the inscription; and
dispensing the item into a dispensing bin of the engraving machine.

17. The method of claim 16, further comprising:
changing the distance of the laser head from the item based on a radius of curvature of the item.

18. The method of claim 17, further comprising:
repeatedly changing the distance of the laser head from the item when the radius of curvature is less than a predetermined threshold; and
holding the distance of the laser head from the item unchanged when the radius of curvature is greater than or equal to the predetermined threshold.

19. The method of claim 16, further comprising:
moving the laser beam according to a vector type marking scheme to engrave the item with the inscription.

20. The method of claim 16, further comprising:
selecting, as a marking scheme, one of a vector type marking scheme or a raster type marking scheme based on the inscription; and
moving the laser beam according to the selected marking scheme to engrave the item with the inscription.
